(19) United States
(12) Patent Application Publication
(10) Pub. No.: US 2002/0023026 A1
(43) Pub. Date: Feb. 21, 2002

(54) On-line savings model

(76) Inventors: Kenneth P. Carroll, Newport Beach, CA (US); Jeffrey W. Mahony, Manhattan Beach, CA (US); Mark K. Maruyama, Manhattan Beach, CA (US)

Correspondence Address: STETINA BRUNDA GARRED & BRUCKER, 75 ENTERPRISE, SUITE 250, ALISO VIEJO, CA, 92656, US

(21) Appl. No.: 09/923,145

(22) Filed: Aug. 6, 2001

Related U.S. Application Data
(63) Continuation-in-part of application No. 09/465,343, filed on Dec. 16, 1999.
Application No. 09/465,343 is a continuation-in-part of application No. 09/356,963, filed on Jul. 19, 1999.

(51) Int. Cl. G06F 17/60

(52) U.S. Cl. 705/26

(57) ABSTRACT

An investment method wherein an investment account is initially established on behalf of an end user. In the investment method, an electronic gift certificate is created through the use of a computer for a prescribed gift amount. The gift certificate is thereafter electronically transferred to the end user through the use of a computer, with the gift certificate thereafter being redeemed by the end user for the gift amount. The gift amount is electronically transferred into the investment account, with the gift amount thereafter being transferred from the investment account into an investment product pre-selected by the end user.

### CROSS-REFERENCE TO RELATED APPLICATIONS

The present application is a continuation-in-part of U.S. application Ser. No. 09/465,343 entitled ON-LINE SAVINGS MODEL filed Dec. 16, 1999, which is a continuation-in-part of U.S. application Ser. No. 09/356,963 entitled ON-LINE SAVINGS MODEL filed Jul. 19, 1999, the disclosures of which are incorporated herein by reference.

### STATEMENT RE: FEDERALLY SPONSORED RESEARCH/DEVELOPMENT

(Not Applicable)

### BACKGROUND OF THE INVENTION

The present invention relates generally to financial planning, savings and investment strategies, and more particularly to an on-line or Internet based investment method which is specifically tailored to significantly accelerate and simplify an individual's ability to save money.

Over recent years, two particular topics have been the focus of substantial media attention. One of these topics has been the rapid growth of the global computer network (i.e., the Internet) and the increasing level of influence it is having on virtually every facet of everyday life. A cursory scan of television programming, magazines or newspapers on almost any given day demonstrates how the Internet is becoming a tool of steadily increasing importance for both business and education. According to a recent study, the Internet audience has grown to approximately 41% of all adults in the United States. Though in its infancy the Internet was largely a domain of well-educated affluent men, it is now routinely being embraced by individuals with little college training and/or modest incomes. These shifting demographics have led to the development of a wide array of Internet based businesses which make numerous products and services available to the consuming public. The “electronic shopping” offered by these Internet businesses is increasingly being viewed as a desirable alternative to the more traditional forms of shopping which typically necessitate a trip to a retail outlet or service provider. Those individuals who turn to the Internet to satisfy traditional consumer based needs are often described as participating in “e-commerce”.

The other topic discussed in the media almost as frequently as the growth of the Internet is the performance of the stock market. Over the last few years, this performance has fueled significant growth in the mutual fund industry, and a resultant increase in the profile of financial houses or brokerages which make mutual funds, stocks, bonds and other investment vehicles available to the consuming public. Tying the explosive growth of the Internet to the performance of the stock market, various Internet businesses have recently been established for allowing consumers to engage in securities trading activities while paying commissions which are substantially reduced from those traditionally paid to brokerages. Following the lead of these Internet businesses, many brokerages have themselves implemented on-line services which allow their clients to engage in securities trading over the Internet at a substantial savings in commissions.

Unfortunately, despite the exponential growth of the Internet and number of on-line brokers in the stock market, many individuals still do not have an alternative to help them save the amount needed to ensure their long-term financial security. Though many individuals are aware of the necessity of saving funds for various financial needs such as college tuition and retirement, only about one-third of the households in the United States own a stock, bond, or mutual fund outside of a 401(k) that one or more members of the household may participate in through their employer. Though many of these individuals have access to the Internet, have some investment income, expect to participate in e-commerce, and have meaningful financial goals to focus on, the lack of efficient savings alternatives in securities (outside their employer based 401(k)) is the primary factor for these individuals not achieving long-term financial security. Many of these individuals do not reach the basic investment parameters of most mutual funds or securities brokers (on-line and off-line), which are largely based on the size of initial and/or subsequent investments. Another factor is that many middle and lower middle class individuals, despite having some investment income, are not the primary targets of any investment company, and thus are not aware of investment opportunities which may potentially suit their needs and/or risk parameters.

The present invention specifically manipulates compound earning savings and consumption habits, e-commerce, the Internet and the financial markets in order to provide superior long-term saving and investment opportunities to people who are largely ignored by today's investment companies, thus allowing such under-served investors the opportunity to save toward their financial goals. As will be described in more detail below, the present invention allows a consumer to open or establish an on-line investment account with no minimum balance, and to contribute money to this account by initiating a transfer via their computer from a savings or checking account in small increments. For example, if the consumer skips a dinner out, he or she can transfer the savings sum (perhaps as little as $5.00) to the investment account. As such, the consumer is afforded an opportunity to save the way he or she may normally save, rather than in large sums that would otherwise be more difficult to put together. Further in accordance with the present invention, individuals having an investment account will be eligible to receive rebates from various retailers and/or credit card merchants for on-line and off-line purchases, with such rebates also being transferred into the investment account for purposes of rapidly accelerating the net value thereof. Still further in accordance with the present invention, gift owners will have the ability to electronically transmit monetary gifts to an individual having an investment account, with such gift certificate being redeemable by the account holder and the proceeds thereof being transferable into the account holder's investment account for subsequent transfer into an investment product if so desired. Such electronic gift certificate can also be created and electronically transmitted to an individual not having an investment account, with the redemption of such gift certificate being coupled with instructions regarding the establishment of an investment account and transfer of the proceeds of the redeemed gift certificate thereinto. These, and other features of the present invention, will be discussed below.

### BRIEF SUMMARY OF THE INVENTION

In accordance with the present invention, there is provided an investment method wherein the net value of an investment account established on behalf of an end user is increased via gift contributions. In the present investment method, the investment account is established with an institution having a defined relationship with at least one retailer wherein the retailer agrees to deposit a rebate sum corresponding to a completed purchase transaction into the investment account. The investment account is structured to generate a return at an estimated annual rate on any sums deposited therein, and to have a net value corresponding to a total of the deposited sums and the return generated in relation thereto. In this regard, it is contemplated that the institution, in addition to having defined relationships with one or more retailers, will also have a defined relationship with at least one investment product provider which agrees to invest any sums deposited into the investment account into an investment product structured to generate the return.

In the present method, a gift donor creates an electronic gift certificate through the use of a computer. The gift certificate is created for a prescribed gift amount. It is contemplated that the gift amount may be for a minimum level (e.g., $25.00 or greater). Upon the creation of the electronic gift certificate, the same is electronically transmitted, through the use of a computer, to an end user/recipient. If the recipient has already established an investment account with the institution (i.e., is already a member), the recipient will be instructed by the institution to redeem the gift certificate and apply the gift amount to the investment account. In this regard, upon the redemption of the gift certificate, the gift amount is electronically transferred into the recipient's investment account. Upon such redemption, the gift donor is provided with an electronic communication (i.e., an e-mail) informing them that the recipient has claimed the gift, i.e., redeemed the electronic gift certificate. A personalized e-mail message is also initially sent by the institution to the recipient informing them of the gift certificate created on their behalf. It is contemplated that such e-mail to the recipient will include a link embedded therein which, when clicked upon, directs the recipient to a web page displaying the electronic gift certificate. Upon being directed to such web page, the recipient is asked to validate that they are the designated recipient and to claim the gift. Upon the transfer of the gift amount for the redeemed gift certificate into the investment account, the gift amount may thereafter be transferred from the investment account into the investment product(s) pre-selected by the end user/recipient.

If, on the other hand, the recipient is not already an investment account holder with the institution, the web page to which the recipient is initially directed will provide the recipient with instructions for opening an investment account subsequent to the recipient validating that they are the designated recipient and have claimed the gift. It is contemplated that the gift donor must use a credit card to facilitate the creation of the gift certificate. Upon the transmission of the gift certificate to the recipient, it is contemplated that the recipient will have thirty (30) days to claim the gift. If the recipient does not claim the gift, then the credit card of the donor will be credited for the gift amount, with the gift thus being considered null and void. This thirty day expiration period starts from the day the electronic gift certificate is sent to the recipient.

In accordance with the present investment method, the electronic gift certificate may be sent to a minor. However, if sent to a minor who does not have an existing investment account with the institution, a custodian (typically the minor's guardian) must open the investment account on the minor's behalf. Once the gift is redeemed by a custodian for the child, the child is the legal account holder of record. The parents (or other custodian of the account) control the account on behalf of the child. Thus, to provide a gift to a minor, the gift donor or giver will need to have the guardian's e-mail address as well.

As in the investment methods described in the parent applications, once the investment account has been established, purchase transactions may be completed with participating, preauthorized retailers for purposes of facilitating the electronic transfer of rebate sums corresponding to the completed purchase transactions into the investment account, thus increasing the net value thereof. These rebate sums may be periodically transferred from the investment account into the investment product, such as when the value of the investment account achieves a pre-selected threshold. Further, the net value of the investment account may also be increased by the end user/member electronically transferring, through the use of a computer, sums from a traditional savings account or checking account into the investment account. These transferred sums can also be periodically transferred from the investment account into the investment product when they alone or in combination with the rebate sum(s) collectively create a value of the investment account which achieves a pre-selected threshold.

### BRIEF DESCRIPTION OF THE DRAWINGS

These, as well as other features of the present invention, will become more apparent upon reference to the drawings wherein:

FIG. 1 is a flow chart illustrating a preferred business model for implementing the investment method of the present invention;

FIG. 2 is a chart providing an exemplary representation of how the net value of an investment account established in accordance with the investment method of the present invention is increased as a result of periodic deposits of rebate sums thereinto; and

FIG. 3 is a flow chart illustrating an alternative embodiment of the business model for implementing the investment method of the present invention in relation to on-line retailers, off-line retailers, other accounts of the investment account holder, and gift donors.

### DETAILED DESCRIPTION OF THE INVENTION

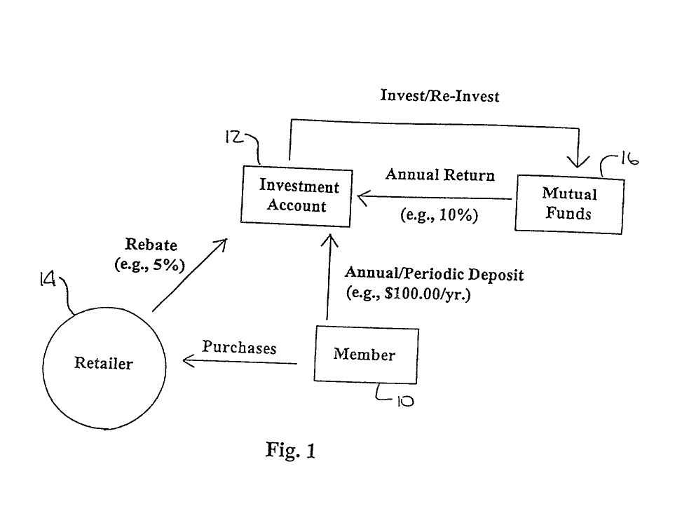

Referring now to the drawings wherein the showings are for purposes of illustrating a preferred embodiment of the present invention only, and not for purposes of limiting the same, FIG. 1 depicts a flow chart which is representative of a preferred business model for implementing the investment method of the present invention. As will be discussed in more detail below, the present investment method is specifically adapted to accelerate and simplify an individual's ability to save money. In the present investment method, a member 10 initially establishes an investment account 12 with an institution (i.e., the provider of the investment account 12) having defined relationships with multiple global computer network (i.e., Internet) or on-line retailers, multiple off-line retailers, and an investment product provider. In the following discussion, these on-line and/or off-line retailers will simply be referred to as the retailer 14 or retailers 14. It is anticipated that the member 10 will most typically be part of that audience of under-served investors referred to above that is largely ignored by today's investment companies. However, those of ordinary skill in the art will recognize that the member 10 may also be from an audience represented by youth who do not believe that social security will provide for them in their golden years, baby boomers who are not content with their current plans for retirement, and older individuals who could use additional savings to purchase long-term care insurance, pay off debts, or are simply thrifty.

Under the defined relationships described above, each on-line and off-line retailer 14 participating in the present investment method will agree to deposit or electronically transfer a rebate sum into the investment account 12. This rebate sum will be generated as a result of a completed purchase transaction between the member 10 and the retailer(s) 14. Such rebate sum may comprise a prescribed percentage of the purchase price for the product or service encompassed by the completed purchase transaction. Alternatively, the rebate sum may comprise a fixed amount unrelated to the purchase price.

In addition to the foregoing, the investment provider participating in the present investment method agrees to invest any sums deposited or electronically transferred into the investment account 12 into an investment product (e.g., the mutual fund(s) 16 shown in FIG. 1) which is structured to generate a return at an estimated rate on any sums invested therein. Thus, as will be recognized, the investment account 12 established by the member 10 will have a net value corresponding to the total of any sums deposited thereinto and the return generated by the investment product in relation to such deposited sums.

In the present investment method, the investment account 12 will be established by the member 10 via interaction with the institution. It is contemplated that the investment account 12 will typically be established by the member 10 through the use of his or her computer upon visiting the web-site of the institution. To establish the investment account 12, the member 10 may be required to deposit a minimum balance amount from his or her bank account (e.g., a savings and/or checking account) to the investment account 12. It is contemplated that the deposit of the minimum balance amount from the bank account of the member 10 into the investment account 12 will be accomplished via an electronic transfer through the use of the computer of the member 10. However, it will be recognized that the present investment method may be implemented without requiring the transfer of the minimum balance amount into the investment account 12 to complete the establishment thereof. The web-site of the institution, which will be discussed in more detail below, will provide the member 10 with all of the information needed to establish the investment account 12, including easy to understand step-by-step instructions which acquire the necessary information from the member 10.

Subsequent to the establishment of the investment account 12, in the present investment method, the member 10 will deposit at least one savings sum from his or her bank account into the investment account 12. Again, it is contemplated that the deposit of the savings sum(s) from the bank account of the member 10 into the investment account 12 will typically be accomplished via an electronic transfer through the use of the computer of the member 10. It is further contemplated that, over time (e.g., one year), the member 10 will transfer multiple saving sums from his or her bank account into the investment account 12 on an intermittent basis.

Those of ordinary skill in the art will recognize that the transfer of the saving sum(s) from the bank account of the member 10 into the investment account 12 may be completed in accordance with any one of numerous different practices. As indicated above, the member 10 may electronically transfer saving sums of small increments from his or her bank account into the investment account 12 on an intermittent basis. Alternatively, the member 10 may choose to electronically transfer one large savings sum from his or her bank account into the investment account 12 on an annual basis (i.e., once a year). As a further alternative, the member 10 may choose to electronically transfer savings sums which are each of a fixed amount from his or her bank account into the investment account 12 on a prescribed, periodic basis.

It is contemplated that each savings sum electronically transferred by the member 10 into the investment account 12 may be of a very small increment (e.g., as low as $5.00). For example, if the member 10 skips a car wash, he or she may electronically transfer $7.00 into the investment account 12, with a night eating at home instead of dining out perhaps compelling a transfer of $30.00 into the investment account 12. The fundamental concept is to allow the member 10 to save money the way he or she may normally save, rather than in larger sums that the member 10 may otherwise have trouble putting together. Because the present investment method contemplates that the savings sums intermittently transferred into the investment account 12 will be of relatively small increments, such transfer will, as indicated above, typically be accomplished electronically through the use of the computer of the member 10. However, the advantages associated with the present investment method are still achieved even if the savings sum(s) are deposited into the investment account 12 in a conventional manner. The hardware architecture and related software architecture needed to implement the required data links between the bank account of the member 10 and the investment account 12 to facilitate the electronic transfer of funds therebetween is well known and established in the prior art.

In addition to transferring the savings sum(s) into the investment account 12, in accordance with the present investment method, the member 10 will preferably complete at least one purchase transaction with one of the on-line or off-line retailers 14 participating in the present investment method. As indicated above, the completion of such purchase transaction will result in the rebate sum being deposited or electronically transferred into the investment account 12. As also indicated above, the rebate sum may correspond to a prescribed percentage of the purchase price related to the completed purchase transaction, or may be a fixed amount unrelated to the purchase price. It is contemplated that the rebate sum will most typically be electronically transferred into the investment account 12, with the source of the rebate sum generally being the retailer 14 itself. For on-line retailers 14, the purchase transaction(s) will typically be completed through the use of the computer of the member 10. Indeed, e-commerce businesses offering individuals a wide array of products and services over the Internet are well known in the prior art, as is the hardware architecture and related software architecture needed to implement the same. Also known in the prior art is the hardware architecture and related software architecture needed to facilitate the necessary data links between the retailers 14 and investment account 12 as is needed to facilitate the electronic transfer of the rebate sum(s) therebetween.

As indicated above, the rebate sum(s) may also be deposited or electronically transferred into the investment account 12 by an off-line retailer 14. For example, a relationship may be established between the institution and a credit card merchant wherein purchases by the member 10 on his or her credit card account with such credit card merchant generate a rebate sum corresponding to a prescribed percentage of the credit card purchases which is transferred into the investment account 12. Indeed, a model similar in principal is known in relation to the Discover® card wherein a rebate is credited to the card holder's account based on a prescribed percentage of the purchases made by the card holder in a given time frame. It is contemplated that as part of the present investment method, the member 10 will, over time, complete multiple purchase transactions with multiple retailers 14 on an intermittent basis.

In the present investment method, the savings sum(s) and rebate sum(s) transferred from the retailer 14 and/or bank account of the member 10 into the investment account 12 are themselves transferred into the investment product. It is contemplated that such transfer will occur immediately upon each savings sum and each rebate sum being deposited or electronically transferred into the investment account 12. Stated another way, upon the transfer of a savings sum into the investment account 12, the same will immediately be transferred into the investment product irrespective of whether the savings sum is of a small amount. Likewise, immediately upon being transferred into the investment account 12, each rebate sum will be transferred into the investment product irrespective of the amount thereof. However, it will be recognized that as an alternative to such immediate transfer, the transfer of the savings and/or rebate sum(s) from the investment account 12 into the investment product may be deferred until such time as the total thereof reaches a minimum level.

In the flow chart shown in FIG. 1, the investment product into which the savings and rebate sum(s) are transferred is one or more mutual funds 16. If the investment product comprises multiple mutual funds 16, the savings and rebate sum(s) will preferably be transferred into respective ones of such mutual funds 16 in accordance with a prescribed allocation. However, those of ordinary skill in the art will recognize that a wide range of investment products are suitable for use in relation to the present investment method. More particularly, as an alternative to the mutual fund(s) 16, the investment product may comprise an annuity, individual stocks, bonds, REIT's, certificate(s) of deposit, or other vehicles that are designed for retirement savings, are easy to administer and reconcile, and are relatively simple in design. The investment products made available to the member 10 may range from those that are conservative to those that are very aggressive. Additionally, the investment product(s) need not be provided by a single provider. The provider of the investment product(s) may also be the institution itself. The hardware architecture and related software architecture needed to facilitate the transfer of the savings and rebate sum(s) from the investment account 12 into the investment product(s) is also well known and established in the prior art. Indeed, similar models are found in brokerages (e.g., Charles Schwab) wherein a client establishes a brokerage account and has the capability of investing the funds therein into any one of a wide variety of investment vehicles, including mutual funds, stocks, bonds, etc.

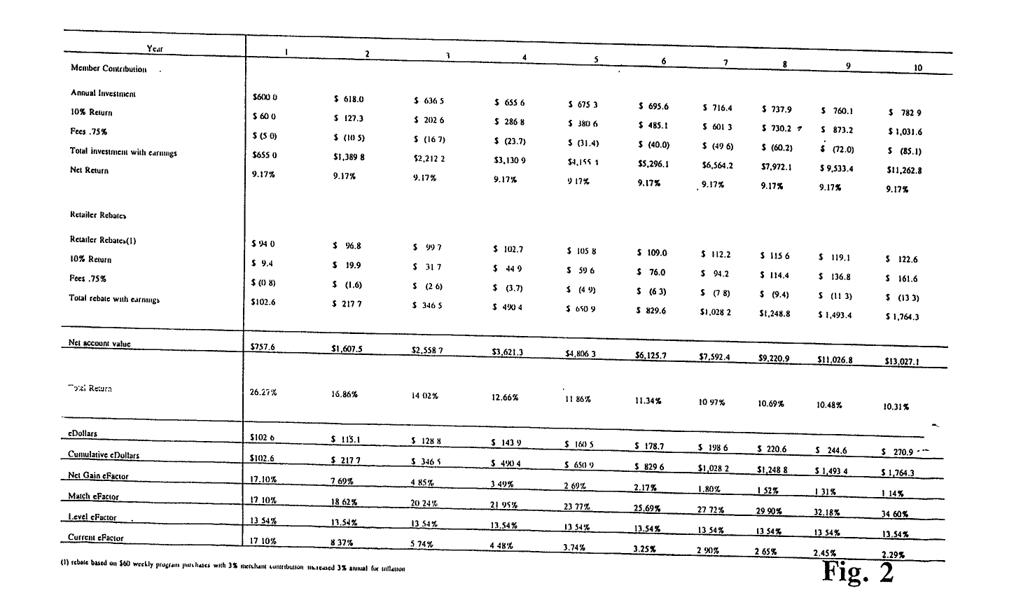

Referring now to FIG. 2, over time, the rebate sums generated as a result of on-line and/or off-line purchases by the member 10 significantly increases the net value of the investment account 12 over that which would be achieved by simply transferring savings sums from the bank account of the member 10 into the investment account 12. The table shown in FIG. 2 provides an exemplary representation of how the present investment method, and more particularly the rebate sums generated as a result thereof, manipulate compound earnings savings in order to provide superior long-term returns. The table shown in FIG. 2 tracks the theoretical performance of the investment account 12 over a ten year period. In the first year, the member 10 transfers a savings sum (referred to as the “annual investment”) of $600.00 into his or her investment account 12. In each succeeding year, this savings sum of $600.00 is increased by three percent to compensate for inflation. The investment product into which the monies in the investment account 12 are transferred is assumed to generate an annual rate of return of ten percent. Additionally, management fees of 0.75% (which will be paid to the institution) are drawn from the investment account 12 on an annual basis. It will be recognized that the savings sum transferred by the member 10 into the investment account 12 on an annual basis may constitute a single, lump sum payment or the combined total of a series of intermittent payments. As is shown in FIG. 2, the net return on the savings sum(s) in the investment account 12 is about 9.17% per year. The “total investment with earnings” referred to in FIG. 2 reflects the compounded return on the savings sums (less management fees) over the ten year period.

In addition to the foregoing, in the table shown in FIG. 2, rebate sums (referred to as “retailer rebates”) totaling $94.00 are assumed to be transferred into the investment account 12 in the first year. This rebate sum of $94.00 corresponds to a rebate percentage of 3% based on on-line and/or off-line purchases by the member 10 with retailers 14 participating in the present investment method in an amount of $60.00 per week (i.e., $3120.00 per year). Thus, in the first year, the $94.00 rebate sum corresponds to 3% of $3120.00. As with the savings sums transferred by the member 10 into the investment account 12, the rebate sums are increased by 3% annually to compensate for inflation. It will be recognized that the $60.00 total of weekly purchases between the member 10 and on-line and/or off-line retailers 14 may occur as the result of a single completed purchase transaction with a single retailer 14, or through the completion of multiple purchase transactions with different retailers 14. In FIG. 2, the “total rebate with earnings” reflects the compounded return on the rebate sums generated over the ten year period.

In FIG. 2, the dollar amount (less management fees) generated on an annual basis as a result of the rebate sums being transferred into the investment account 12 is referred to as “e-Dollars”. In the first year, e-Dollars of $102.60 are generated as a result of the rebate sums being transferred into the investment account 12. In the second year, e-Dollars of $115.10 are generated by the transfer of the rebate sums into the investment account 12. Cumulative totals of the e-Dollars over the ten year period are reflected in the row designated as “Cumulative e-Dollars”. As will be recognized, the Cumulative e-Dollars for any given year in the ten year period comprises the sum of the e-Dollars for a particular year and the e-Dollars for the preceding year(s).

As indicated above, the transfer of the savings sum(s) by the member 10 into the investment account 12 provides the investment account 12 with a net value. The manner in which the increase in the net value of the investment account 12 is accelerated by the e-Dollars is expressed in FIG. 2 in a number of different ways. The “net gain e-factor” reflects the difference between the annual total return generated in relation to the investment account 12 and the net return that would be generated if only the savings sum(s) were invested thereinto. For example, in the first year, the total return based on the savings and rebate sums transferred into the investment account 12 is 26.27%. The net return on the investment account 12 if only the savings sum was transferred thereinto is 9.17%. Subtracting the 9.17% net return from the 26.27% total return demonstrates that the e-Dollars increase the rate of return by the net gain e-factor of 17.10%. Thus, the simple transfer of the rebate sums into the investment account 12 makes a significant impact in the total return generated by the investment account 12.

The “match e-factor” shown in FIG. 2 is derived by dividing the e-Dollars in each year by the annual investment or savings sum for the same year. For example, in the first year, dividing the e-Dollars of $102.60 by the annual investment or savings sum of $600.00 provides the match e-factor of 17.10%. This match e-factor demonstrates that the e-Dollars generated by the transfer of the rebate sum into the investment account 12 in the first year are equal to 17.10% of the savings sum transferred by the member 10 into the investment account 12 in the same year. Thus, the e-Dollars in this scenario may be viewed as providing a benefit similar to that achieved with a traditional 401(k) in that, in the first year of the investment account 12, the e-Dollars represent a “match” of 17.10% of the savings sum or annual investment made by the member 10 into the investment account 12. As is seen in FIG. 2, this “match” increases significantly in each succeeding year over the ten year time period. Indeed, in the tenth year, the e-Dollars generated by the investment account 12 are equal to roughly one-third of the savings sum transferred by the member 10 into the investment account 12 in that year.

The “level e-factor” shown in FIG. 2 is derived by dividing the cumulative e-Dollars in any given year by the net account value of the investment account 12 for the same year. As such, the level e-factor reflects or is representative of that portion or percentage of the net value of the investment account 12 which is attributable to the e-Dollars generated by the transfer of the rebate sums into the investment account 12. As is apparent from FIG. 2, the e-Dollars generated over the course of the ten year period represent about 13.54% of the net account value of the investment account 12 on an annual basis.

Finally, the “current e-factor” shown in FIG. 2 is derived by dividing the e-Dollars in any given year by the sum of the annual investment or savings sum for the same year and the net account value from the preceding year. As such, the current e-factor is representative of that portion of the net account value in any given year represented by the e-Dollars generated by the transfer of rebate sums into the investment account 12 in any given year.

As indicated above, the net gain, match, level and current e-factors shown in FIG. 2 demonstrate the significant impact the e-Dollars (i.e., rebate sums) have on the overall net value of the investment account 12 over that which would be achieved by simply transferring savings sums into the investment account 12. In the present investment method, transactions which occur between the member 10, retailers 14 and investment account 12 essentially mirror the model of the Discover® card wherein the card holder's credit card account is credited based on prescribed percentages of purchases made by the card holder in a given time frame. The transactions between the member 10, investment account 12, and product provider (e.g., mutual funds 16) essentially mirror a basic brokerage account (e.g., a Schwab Account) wherein the account holder transfers funds into his or her brokerage account and has the ability to invest such funds in any one of a wide range of investment vehicles or products. In the present investment method, these two known business models are combined or melded together in a new and novel fashion to provide the increased returns and net value discussed above.

It is contemplated that the returns generated by the present investment method may be further enhanced by the institution itself contributing a savings dividend (i.e., profit sharing) to the investment account 12 of the member 10, thereby creating customer loyalty through participation. It is also contemplated that on the institution's web-site, simple financial models will be available to help each member 10 calculate the long-term savings of current and future investments (e.g., enter $3.00 per day at 12% for 30 years, and realize a savings of $324,746.00). Thus, not only will each member 10 see how their own savings can compound, they will also be able to project the long-term savings from the rebate sums and/or savings dividends. Each member 10 will have the capability to log onto the institution web-site each day to get the current status of the investment account 12, financial planning, budget and investment education, with such available data also including motivational tips, spotlight discount products, and money savings and budgeting chatrooms. As indicated above, the hardware architecture and associated software architecture used to implement the present investment method is based on known systems and models. An exemplary overview of one potential hardware architecture and associated software architecture is set forth in the documents appended hereto at Appendix 1, the entirety of which is incorporated herein by reference.

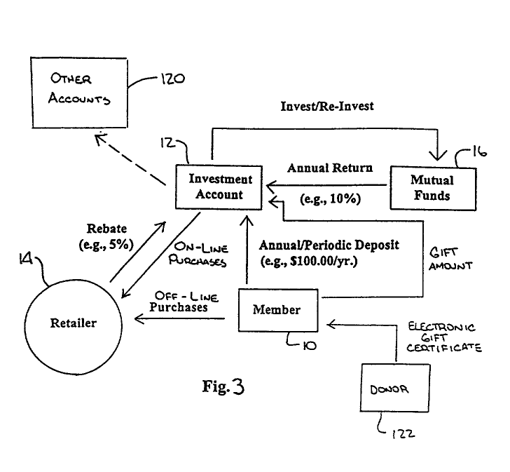

Referring now to FIG. 3, as explained above, it is contemplated that in accordance with the present investment method, the member 10 will preferably complete at least one purchase transaction with either an on-line or off-line retailer 14. The completion of such purchase transaction will result in a rebate sum corresponding thereto being electronically transferred into the investment account 12. As previously indicated, the rebate sum may correspond to a prescribed percentage of the purchase price related to the completed purchase transaction, or may be a fixed amount unrelated to the purchase price. To establish the necessary communications or data links between the retailer 14 and the investment account 12, it is contemplated that the investment account 12 will itself serve as the vehicle or conduit for the completion of on-line purchase transactions (i.e., the transactions will be completed through the investment account 12 after accessing the same via the computer).

More particularly, after the investment account 12 is accessed via the computer, a communications link may by electronically established between the account holder and the retailer 14 via the investment account 12 itself. To this end, the web-site of the institution which is used by the member 10 to gain access to the investment account 12 will provide the necessary links to establish electronic communication with the retailer 14 via the investment account 12. Upon the establishment of such communications link, the purchase transaction may be completed by the member 10. The completion of the purchase transaction through the investment account 12 establishes the necessary communications or data links as are needed to allow the retailer 14 to electronically transfer the rebate sum or commission to the investment account 12. As will be recognized, the on-line purchase transactions completed through the investment account 12 will typically involve on-line retailers 14 having an established relationship with the institution.

It is further contemplated that the investment account 12 may be structured to allow third parties (i.e., grandparents, friends, etc.) to access the same for purposes of completing on-line purchase transactions through the investment account 12. Appropriate safeguards would be put into place or implemented on the institution's web-site to prevent such third parties from manipulating or liquidating the assets of the investment account 12, and to limit such third parties solely to completing on-line purchase transactions through the investment account 12. Thus, the revenue generated within the investment account 12 attributable to the rebate sums generated from completed on-line purchase transactions could be substantially increased in that such revenue can be derived not only from purchase transactions completed by the investment account holder or member 10, but by family and friends of the member 10 as well.

In addition to foregoing, it is contemplated that the investment account holder or member 10 may accumulate purchase bonus points corresponding to completed purchase transactions with on-line retailers 14 facilitated through the investment account 12. These purchase bonus points may, at the option of the member 10, be allocated or transferred to the account of another investment account holder or member.

As indicated above, the on-line purchase transactions completed through the investment account 12 of the member 10 will typically involve on-line retailers 14. As will be recognized, for rebate sums to be deposited or electronically transferred into the investment account 12 in relation to off-line purchase transactions completed between the member 10 and off-line retailers 14, it is necessary to establish a data or communications link between such off-line retailer 14 and the investment account 12. In this regard, it is contemplated that a “swipe card” can be employed in relation to the present business model to provide necessary information regarding the investment account 12 to an off-line retailer 14 for purposes of allowing a rebate sum corresponding to the completed purchase transaction with the off-line retailer 14 to be deposited or electronically transferred into the investment account 12. The hardware and software architecture related to this card swipe technology is known in the prior art, and typically implemented in various establishments such as grocery stores. The use of the swipe card also provides a vehicle for members 10 who are not comfortable with computers to nonetheless facilitate the deposit of a rebate sum into either their investment account 12 or the investment account of another. Third party non-members may also be able to use a swipe card in relation to their off-line purchase transactions with off-line retailers 14 to facilitate the electronic transfer of the rebate sum corresponding to the purchase transaction into the investment account 12 of the member 10.

As is further seen in FIG. 3, it is also contemplated that in accordance with the present invention, the investment account 12 of the member 10 may be electronically linked to another account 120 of the member 10 such as a credit card account or a life insurance account. In this respect, the “microinvestments” electronically transferred into the investment account 12 (i.e., the savings and rebate sums) could be used to satisfy other debt obligations of the member 10 such as the payment of life insurance premiums or the pay-off of credit card debt. Once such debt obligations are satisfied, the communications link between the investment account 12 and the other account 120 of the member 10 could be terminated or discontinued, thus allowing for the net value of the investment account 12 to be increased in the above-described manner by the electronic transfer of the savings and rebate sums deposited therein into the mutual funds 16 or other investment product.

As further seen in FIG. 3, it is also contemplated that a gift donor 122 (who is or is not a member 10) may create an electronic gift certificate through the use of a computer. As indicated above, the gift certificate is created for a prescribed gift amount, with it being contemplated that the gift amount will be for a minimum level such as twenty-five dollars or greater. As seen in FIG. 3, upon the creation of the electronic gift certificate, the same is electronically transmitted to the member 10. Since the member 10 already has established the investment account 12, the member 10 will be instructed to redeem the gift certificate and apply the gift amount to the investment account 12. In this regard, upon the redemption of the gift certificate, the gift amount is electronically transferred into the investment account 12. Upon such redemption, the gift donor 122 is provided with an e-mail informing him/her that the member 10 has redeemed the electronic gift certificate. An e-mail message is also initially sent to the member 10 informing him/her that the gift certificate has been forwarded on their behalf. It is contemplated that such e-mail to the member 10 will include a link embedded therein which, when clicked upon, directs the member 10 to a web page displaying the electronic gift certificate. Upon being directed to such web page, the member 10 is asked to validate that they are the designated recipient and to claim the gift. Upon the transfer of the gift amount for the redeemed gift certificate into the investment account 12, the gift amount may thereafter be transferred from the investment account 12 into the investment product(s) (e.g., mutual funds 16) pre-selected by the member 10.

As explained above, if the recipient of the gift certificate is not already an investment account holder (i.e., member 10), the web page to which the recipient is initially directed will provide the recipient with instructions for opening an investment account 12 subsequent to the recipient validating that they are the designated recipient and have claimed the gift. It is also contemplated that the gift donor 122 must use a credit card to facilitate the creation of the gift certificate. Upon the transmission of the gift certificate to the recipient, it is contemplated that the recipient will have thirty (30) days to claim the gift. If the recipient does not claim the gift, then the credit card of the donor 122 will be credited for the gift amount, with the gift thus being considered null and void. This thirty day expiration period starts from the day the electronic gift certificate is sent to the recipient.

As also explained above, the electronic gift certificate may be sent to a minor. However, if sent to a minor who does not have an existing investment account 12, a custodian (typically the minor's guardian) must open the investment account 12 on the minor's behalf. Once the gift is redeemed by the custodian for the child, the child is the legal holder of the investment account 12. The parents (or other custodian of the investment account 12) control the investment account 12 on behalf of the child. Thus, to provide a gift to a minor, the donor 122 will need to have the guardian's e-mail address as well.

Additional modifications and improvements of the present invention may also be apparent to those of ordinary skill in the art. Thus, the particular combination of steps described and illustrated herein is intended to represent only one embodiment of the present invention, and is not intended to serve as limitations of alternative methods within the spirit and scope of the invention.

1. In an investment scheme wherein sums are transferred from an investment account associated with an end user into an investment product pre-selected by the end user, the improvement comprising:
a) creating, through the use of a computer, an electronic gift certificate for a prescribed gift amount;
b) electronically transmitting, through the use of a computer, the gift certificate to the end user;
c) redeeming the gift certificate for the gift amount;
d) electronically transferring the gift amount for the redeemed gift certificate into the investment account; and
e) transferring the gift amount from the investment account into the investment product.

2. The method of claim 1, further comprising the steps of:
f) completing at least one purchase transaction with at least one pre-authorized retailer for a prescribed purchase price;
g) electronically transferring a rebate sum corresponding to a prescribed percentage of the purchase price into the investment account; and
h) transferring the rebate sum from the investment account into the investment product.

3. The method of claim 2 wherein step (f) comprises completing multiple purchase transactions on an intermittent basis.

4. The method of claim 3 wherein the retailer is a global computer network retailer, and step (f) is accomplished through the use of a computer.

5. The method of claim 3 wherein step (h) is completed subsequent to a total of the rebate sums deposited into the investment account under step (g) reaching a minimum level.

6. The method of claim 1 further comprising the step of:
f) cancelling the gift certificate if the redemption of the gift certificate under step (c) is not completed within a prescribed period of time.

7. An investment method, comprising the steps of:
a) establishing an investment account associated with an end-user with an institution having defined relationships with at least one retailer and an investment product provider wherein the retailer agrees to electronically transfer a rebate sum corresponding to a completed purchase transaction to the institution for deposit into the investment account, and the investment product provider agrees to invest any sums deposited into the investment account into an investment product pre-selected by the end user and structured to generate a return at an estimated annual rate on any sums invested therein, the investment account having a net value corresponding to a total of any sums deposited thereinto and the return generated by the investment product in relation thereto;
b) creating, through the use of a computer, an electronic gift certificate for a prescribed gift amount;
c) electronically transmitting, through the use of a computer, the gift certificate to the end user;
d) redeeming the gift certificate for the gift amount;
e) increasing the net value of the investment account by electronically transferring the gift amount for the redeemed gift certificate thereinto; and
f) transferring the gift amount from the investment account into the investment product.

8. The method of claim 7 further comprising the steps of:
g) completing, through the use of a computer, multiple purchase transactions on an intermittent basis with the at least one retailer;
h) increasing the net value of the investment account by electronically transferring rebate sums generated under step (g) thereinto; and
i) periodically transferring the rebate sums from the investment account into the investment product when a value of the investment account achieves a pre-selected threshold.

9. The method of claim 7 further comprising the step of:
g) cancelling the gift certificate if the redemption of the gift certificate under step (d) is not completed within a prescribed period of time.

10. An investment method, comprising the steps of:
a) establishing an investment account with an institution having a defined relationship with at least one retailer wherein the retailer agrees to provide a rebate sum corresponding to a completed purchase transaction for deposit into the investment account, the investment account being structured to generate a return at an estimated annual rate on any sums deposited therein and to have a net value corresponding to a total of the deposited sums and the return generated in relation thereto;
b) creating, through the use of a computer, an electronic gift certificate for a prescribed gift amount;
c) electronically transmitting, through the use of a computer, the gift certificate to the end user;
d) redeeming the gift certificate for the gift amount; and
e) increasing the net value of the investment account by electronically transferring the gift amount for the redeemed gift certificate thereinto.

11. The method of claim 10, further comprising the steps of:
f) completing, through the use of a computer, at least one purchase transaction with the retailer;
g) increasing the net value of the investment account by electronically transferring the rebate sum thereinto; and
h) transferring the rebate sum from the investment account into an investment product pre-selected by the end user.

12. The method of claim 10 further comprising the step of:
f) cancelling the gift certificate if the redemption of the gift certificate under step (d) is not completed within a prescribed period of time.

13. An investment method, comprising the steps of:
a) establishing an investment account associated with an end user;
b) creating, through the use of a computer, an electronic gift certificate for a prescribed gift amount;
c) electronically transmitting, through the use of a computer, the gift certificate to the end user;
d) redeeming the gift certificate for the gift amount;
e) electronically transferring the gift amount for the redeemed gift certificate into the investment account; and
f) transferring the gift amount from the investment account into an investment product pre-selected by the end-user.

14. The method of claim 13 further comprising the steps of:
g) completing at least one purchase transaction with at least one pre-authorized retailer for a prescribed purchase price;
h) electronically transferring a rebate sum corresponding to a prescribed percentage of the purchase price into the investment account; and
i) transferring the rebate sum from the investment account into the investment product.

15. The method of claim 13 further comprising the step of:
g) cancelling the gift certificate if the redemption of the gift certificate under step (d) is not completed within a prescribed period of time.

16. An investment method, comprising the steps of:
a) creating, through the use of a computer, an electronic gift certificate for a prescribed gift amount;
b) electronically transmitting, through the use of a computer, the gift certificate to an end user;
c) establishing, through the use of a computer, an investment account associated with the end user;
d) redeeming the gift certificate for the gift amount;
e) electronically transferring the gift amount for the redeemed gift certificate into the investment account; and
f) transferring the gift amount from the investment account into an investment product pre-selected by the end user.

17. The method of claim 16 further comprising the steps of:
g) completing at least one purchase transaction with at least one pre-authorized retailer for a prescribed purchase price;
h) electronically transferring a rebate sum corresponding to a prescribed percentage of the purchase price into the investment account; and
i) transferring the rebate sum from the investment account into the investment product.

18. The method of claim 17 wherein step (g) comprises completing multiple purchase transactions on an intermittent basis.

19. The method of claim 18 wherein the retailer is a global computer network retailer, and step (g) is accomplished through the use of a computer.

20. The method of claim 18 wherein step (i) is completed subsequent to a total of the rebate sums deposited into the investment account under step (h) reaching a minimum level.

21. The method of claim 16 further comprising the step of:
g) cancelling the gift certificate if the redemption of the gift certificate under step (d) is not completed within a prescribed period of time.
